(19) United States
(12) Patent Application Publication
(10) Pub. No.: US 2010/0300481 A1
(43) Pub. Date: Dec. 2, 2010

(54) Multifilament braided dental floss

(76) Inventor: Zoya Lavrova, Brooklyn, NY (US)

Correspondence Address: Aleksandr Smushkovich, POB 140505, Brooklyn, NY, 11214, US

(21) Appl. No.: 12/455,387

(22) Filed: Jun. 1, 2009

(51) Int. Cl. A61C 15/04

(52) U.S. Cl. 132/321

(57) ABSTRACT

A dental floss is disclosed, consisting of sections twisted relatively to each other along a longitudinal direction at predetermined angles providing a permanently changeable spatial orientation of the sections. The sections each consists of strands braided with each other in a multi-stitch manner so that the sections collectively form a volumetric knit structure having a longitudinal axis. The structure, being horizontally disposed, forms a projection on any axial plane, extended through the longitudinal axis, which projection represents a planar pattern having an upper contour and a lower contour with a periodically changing width therebetween, thereby forming concave and convex portions. The disclosed floss provides for a unique adhesive property increasing the floss cleaning power, grabbing and removing plaque particles from the tooth surface more efficiently than the conventional ones. It's exemplarily produced by means of adapted overlock machines, of polyester, colored, flavored, un-waxed, waxed, or impregnated with specific therapeutic agents.

### FIELD OF THE INVENTION

The present invention relates to the oral care field, particularly to multi-filament floss devices with particular braided patterns.

### BACKGROUND OF THE INVENTION AND RELATED ART

It is generally recognized in the dental profession that plaque, which remains on the teeth after brushing, is a major cause of tooth and gum problems. Flossing is an effective process for individuals to remove the plaque. Without dental flossing, this plaque remains and provides a shelter for bacteria to continue metabolizing carbohydrates, excreting acid and thus attacking tooth enamel. Plaque build-ups not only lead to tooth decay and gum disease, but have been linked to other serious health problems as well.

Dental floss is a device that removes plaque and debris adhered to a person's teeth, restorations, fixed prostheses, pontics (artificial teeth), and around implants. In general, inter-proximal contact areas, whether natural or restored, have different configurations. Consequently, several types of floss devices are available to accommodate these differences. It is known that no floss on the market has received a degree of perfection that satisfies both dental professionals and consumers.

The majority of flosses currently known in the related art do not provide a sufficient quality of cleaning between teeth, mostly because they are smooth and flat. Conventional flosses do not have anchoring points which would permit an efficient pick-up and consequent removal of the food residues from the inter-proximal dental regions. Furthermore, due to the limitations in the surface topography of known flosses, there is little or no salutary massage to the gum surfaces surrounding the teeth. They provide only an inefficient means of transporting the dislodged particles from the surface which they contact with. Conventional flosses do not reach into the pockets of gum dis-attachments within the inter-proximal regions in the gingival direction, nor do they contact concave surface of the radial contours of teeth.

Another disadvantage of the conventional dental flosses is that the gingiva is damaged due to forceful contact of the dental floss therewith. If the gingiva is in a diseased or unhealthy state, it often swells and bleeds easily, which discourages the continual use of flosses.

The conventional dental flosses are generally composed of relatively small diameter filaments woven together into single elongated strands. Most common commercial floss products are structured as a multifilament thread of different length. However, they tend to fray or split, do not have the capacity to show vividly the existence of the plaque between the teeth.

Numerous floss devices are presented in the related art. For example, there is known US Patent Application No. 2003/0154998 by Alexandre Petrocini Falleiros et. al. It refers to a texturized dental floss for interdental cleaning usually used for removing of the food debris. The floss is formed of a bundle of texturized filaments in which the filaments are unwound and then impregnated with additive composition. The texturized flosses have higher contact surface with inter-proximal surface of tooth surfaces and good capacity for removal of food residues, but texturized flosses have occurrence for threading in the inter-proximal dental regions in which the floss may kink and bend. The texturized flosses and the floss of instant invention, also called ‘Magic Floss’ have completely different structures: the texturized flosses are uneven while the Magic Floss is knitted.

Another example is US Patent Application No. 2007/0144553A1 by Pamela Jill Habbard. It teaches a dental article comprising a primary strand of coated dental floss and accessory fiber of uncoated dental floss attached to the primary strand by overhand knots or other means is provided. The article provides effective cleaning of embrasures and stimulation of the gingival tissues, but its use is limited and too specific. This floss is targeted for cleaning of areas of embrasures. The Habbard's floss has specific structure and may not be employed by every consumer in everyday use.

A U.S. Pat. No. 5,063,948 teaches a bristle dental floss comprising a plurality of sub-fibers each having a plurality of bristles. Many small pieces thereof are tied to the long stands, and many of the same short pieces tied to the bristle ends. The sub-fibers, bristles, or both may be stiffened with wax, Teflon, nylon, or similar materials. The bristled dental floss has improved cleaning and massaging abilities for cleaning inter-proximal regions. Teflon has a number of specific physical properties including great chemical and physical inertness that makes it very difficult to use the material in combination with other materials. Besides, Teflon tends to break or rip quickly when it is stretched or pulled with pressure. Thus, Teflon is difficult to employ in dental flossing. Bristles are attached by hitch-type knots. The aforementioned structure is complex and not easy to manufacture, which adversely affects the price and has made the invention unattractive to consumers.

U.S. Pat. No. 5,560,377 is related to improved floss comprising a composite of multifilament yarn bonded to an extruded monofilament. Both elements are made of polymer compounds, preferably nylon. The multifilament yarns can be provided in looped embodiments as a bush element or in the form of one or more tails. In the mentioned patent, only part of the floss performs the mopping function. The multifilament thread or yearn is extruded and bonded into a monofilament using electronic welding, or gluing, or adhering, or air splicing.

U.S. Pat. No. 4,836,226 includes abrasive surface of either rips or dimples. This is an attempt to solve the problem of providing sufficient cleaning and removing debris from the dental textures.

U.S. Pat. No. 6,607,000 is a frilly dental floss formed of a thin wide ribbon with frilly edge or centrally located slits made of strong waxed polymer (HDPE). The taught floss has improved cleaning structure and may scoop and pull out any amount of material or plaque from within the gingival sulcus area and from the tooth surface.

There is known a texturized dental floss ‘Superfloss’ produced by Colgate/Palmolive Company used to clean large inter-dental spaces that have bridges and various dental prostheses. It has a greater diameter and is more effective in removing food debris. The larger diameter and the fibrous nature provide good cleaning action but in contact with saliva the floss quickly softens and loses its cleaning abilities.

U.S. Pat. No. 4,265,258 describes a relatively large diameter dental floss having a multitude of fibers overlain upon each other, in some cases extending beyond the main body of the floss. Although such a configuration provides an alternative to conventional flosses, this overlain floss could not clean the concave surface of the tooth. Furthermore, such approach provides little improvement over the conventional flosses.

### OBJECTS AND GENERAL DESCRIPTION OF THE INVENTION

### Objects of the Invention

A primary object of the instant invention, herein also called ‘Magic Floss’, is to provide an improved dental floss that delivers more effective removal of plaque and thereby results in minimization of action of the bacteria that cause tooth decay and gum disease.

Another object is to provide a dental floss that reinforces the effectiveness of bound therapeutic agents.

Another object is to provide an improved dental floss which is enhanced by pleasant flavoring and coloring.

Yet another object is to provide an endless loop floss so designed that can be engaged by the fingers of a user to assist in the flossing manipulation. Producing the endless looped floss should not require heat sealing, knotting, gluing, electronic welding, or air splicing of the floss to make the loop.

Other objects of the invention may become apparent to those skilled in the art upon learning the present disclosure.

### Structure of the Inventive Floss

According to the instant invention, the foregoing objects and other features and advantages have been attained by creating a dental floss with knit structure. In preferred embodiments, this floss can be made of silk, polyester, or of a combination of polyester and cotton threads. Polyester is continuous filament and unlike many known materials is not spun from many short fibers. Polyester is strong and does not break apart. It has a sufficient stretching capacity without destruction (‘stretchable’), while a spun yearn does not. Because of its stretchability and its lengthy structure, polyester is soft and gentle when flossing is done around the gum line.

The knit structure of the floss factually provides a novel teeth cleaning technology with outstanding quality. In preferred embodiments, the knit floss consists of strands braided with each other in a multi-stitch (or multi-looped) manner so that collectively form a volumetric knit structure having a longitudinal axis. If the floss is horizontally disposed, a projection of the structure on any axial plane, extended through the longitudinal axis, represents a planar pattern having an upper contour and a lower contour with a periodically changing width therebetween, i.e. having ‘concave’ and ‘convex’ portions. Therefore, the knit structure consists of a plurality of multi-stitch sections twisted in relation to each other along the longitudinal direction at predetermined angles (that provides a permanently changeable spatial orientation of the sections), which sections are herein called ‘facets’.

This concave-convex braided structure has an advantage in comparison with the conventional smooth floss structure in terms of delivering higher cleaning power. The aforesaid facets provide a unique adhesive property of Magic Floss that allows grabbing and removing plaque particles from the surface of tooth more efficiently than the conventional floss with a plain surface structure does. The non-flat surface of the inventive floss is more abrasive and less slippery than the flat floss structure. The inventive Magic Floss has a greater contact surface with the inter-proximal surface of the teeth as well as a good capacity for removing the food residues, which are usually retained in the interstices of the threads.

An improved abrasive cleaning action takes place due to the arrangement of the facets that allow for cleaning the inter-proximal tooth surfaces by longitudinal movement, as well as by transverse movement. Because the material of the inventive floss is stretchable, the floss becomes ‘pushable’, i.e. it provides for inserting the inventive floss into spaces generally inaccessible for conventional flosses due to the proximity of adjoining teeth.

Magic Floss maintains essentially permanent unaltered elasticity and flexibility. The facets greatly increase the cleaning and removal capacity of the inventive floss. Nonetheless, since the material of the inventive floss is soft enough, the abrasion is limited and the floss will scrub the side of the tooth while treating the gum gently. The facets are mildly depressed against the gum line and remove plaque therefrom as well. It also allows for removing more than twice as much plaque as conventional flosses do. An un-waxed conventional floss can occasionally fray or tear, if it is inserted into or removed from tight contacts formed by overlapping teeth, or if heavy calculus deposits or defective restorations are present. Frequent floss breakage may discourage continuous use of the floss. The knit structure of the inventive floss prevents such breakage or fraying.

Magic Floss may be produced in a variety of colors. The colored floss provides the visual contrast with plaque and oral debris, thus enabling to see what is being removed. That allows patients to see the immediate results of flossing, and helps them to establish self-control over the process of cleaning. This increases the motivation and encourages further use of the inventive floss.

Magic Floss can be made un-waxed, waxed, flavored and impregnated with a variety of liquid therapeutic agents. Due to the volumetric knit structure, the inventive floss has a capacity to take on moisture and has enhanced lubricant characteristics. It may contain and easily carry medications, which are useful for treatment of gum diseases and for prevention of tooth decay. Such medications may include various components, e.g. ions of fluorine, sodium laurite, sodium perborate, alantoin, myrrh extract, charcoal, and xylitol. Friction heat is often generated, when dental flosses are pulled over the teeth and especially between the teeth at the point of contact. The inventive knit structure and friction heat reinforce effectiveness of the medication components.

Flavor encourages the regular usage of dental floss. Magic Floss can be furnished with mint, orange, lemon, cherry, strawberry, vanilla, and other flavors.

Dental flossing is usually done manually when the floss is held by the fingers of both hands. Use of the floss typically involves pulling an appropriate section of the floss thread from the packaging, severance of the withdrawn section, wrapping the section's ends around two fingers on opposite hands, and then working the section in the inter-teeth spaces while maintaining it in a tight state. These manipulations require a degree of dexterity, which makes the flossing process unattractive to many people and very difficult for most children. In addition, the maintaining of tension required for effective plaque removal causes the thread to stick into and cut the user's fingers.

A device known as a ‘floss holder’ can assist individuals, whose functional abilities or oral architecture cannot accommodate the manual flossing. However the technique does not allow flossing under the gingival tissue without cutting the gum, and does not allow encircling the proximal surface at a required angle. The single unit floss does not permit cleaning all proximal surfaces of teeth.

For such users, an embodiment of Magic Floss in the form of ‘endless loop’ (or ring) with the above described knit structure can be recommended. This embodiment allows for moving the endless loop floss easily up and down between the teeth at least two times to remove soft deposits. During the flossing procedure, as one section of the floss has done its cleaning, a fresh section of the endless loop can be easily rotated into the use without the rewinding and unwinding the floss from one hand into the other. The knit structure of Magic Floss allows for making the endless loop without a knot, since such knot would be unacceptable for flossing.

There are dental flosses on the market that combine thin ‘floss’ portions with thick ‘brush’ portions coupled with a so called ‘threader’. Such flosses are usually used for cleaning under pontics and between teeth with exposed roots and furcations. However, such cleaning becomes unsatisfactory because the spongy ‘brush’ portion turns wet from saliva and softens. This feature reduces the effectiveness of brush cleaning for such flosses. The inventive knit floss excludes this problem of losing the cleaning effectiveness while being in contact with saliva. Whether it is dry or wet, the facets of Magic Floss entrap the particles of plaque. Thusly, the invention enables consumers to achieve better overall results, inexpensively, safe, and in a much pleasurable manner.

### Preferred Method and Machines for Manufacturing the Inventive Floss

According to the present invention, a preferable method for manufacturing the Magic Floss contemplates the use of an adapted conventional ‘overlock’ sewing machine. With respect to the instant description, suitable sizes, materials, and manners of operation can be used. The inventive knit floss may be produced with different thickness and width. The wider and softer flosses can be used for cleaning larger surface areas (under bridges, pontics, through exposed roots and furcations). This sort of inventive floss may be recommended for cleaning implant abutments, areas with open contacts, and wide embrasures. It can also be used to remove plaque from distal aspects of the most distal teeth in all quadrants.

The following overlock sewing machines were practically used for experimental manufacturing the Magic Floss: Juki MO-2516 N class FF6-50H; Willcox and Gibbs type 504-E56-130; and Merrow Style # M-3DW-4 serial number 143548. However, any overlock sewing machine could be adapted for manufacturing this type of floss.

Because the inventive knit floss may be produced with a various thickness and width, and the machines are not used for stitching or overlooking a regular fabric, the sewing machines require some insignificant adaptation. The Juki overlock sewing machine MO-2516 N class FF6-50H was used to manufacture a finer floss, which had two needles and five threads. The adaptation was provided so that one needle and three threads were removed. In this machine, only a double chain looper worked during the manufacturing of Magic Floss, but the upper and lower loopers did not operate.

For manufacture of the inventive floss with the Willcox and Gibbs overlock machines, one of the three threads was removed with the other two threads remaining. The presser foot was also removed. The upper looper was substituted with a blind looper to produce a thinner thread chain.

For floss manufacture with the Merrow machine, no changes were required, but it produced a thicker floss to remove the plaque under bridges and the exposed furcation areas.

The machines needed readjustment of the thread tension. The tension of the side thread should be increased and the thread tension in the needle should be decreased.

### BRIEF SUMMARY OF THE INVENTION

Therefore, the invention provides a dental floss consisting of a plurality of multi-stitch sections twisted in relation to each other along a longitudinal direction at predetermined angles providing a permanently changeable spatial orientation of the sections; the sections each consists of strands braided with each other in a multi-stitch manner so that the sections collectively form a volumetric knit structure having a longitudinal axis; the structure, being horizontally disposed, forms a projection on any axial plane, extended through the longitudinal axis, wherein the projection represents a planar pattern having an upper contour and a lower contour with a periodically changing width therebetween, thereby forming concave and convex portions.

### BRIEF DESCRIPTION OF THE DRAWINGS

FIGS. 1a, 1b, 1c , and 1d schematically and in an enlarged scale illustrate different patterns of Magic Floss, according to embodiments of the present invention.

FIG. 2 schematically shows a roll Magic Floss, according to an embodiment of the present invention.

FIG. 3a shows a conventional floss positioned on the mesial surface of a maxillary first premolar.

FIG. 3b illustrates the cleaning of the maxillary first premolar with Magic Floss, according to an embodiment of the present invention.

FIG. 4 illustrates the cleaning and stimulation of gingiva of embrasures with missing inter-dental papilla by Magic Floss, according to an embodiment of the present invention.

FIG. 5 illustrates the cleaning of a tooth adjacent to the edentulous area by Magic Floss, according to an embodiment of the present invention.

FIG. 6 illustrates the cleaning of an exposed furcating area by inserting Magic Floss and moving it back and forth, according to an embodiment of the present invention.

FIG. 7 illustrates Magic Floss, which can be moved all the way down to the gum line to the triangular socket, according to an embodiment of the present invention.

FIG. 8 illustrates the endless loop embodiment of Magic Floss, according to an embodiment of the present invention.

FIG. 9 illustrates the sliding of Magic Floss under a pontic, according to an embodiment of the present invention.

FIGS. 10 and 11 illustrate the cleaning around abutments, according to an embodiment of the present invention.

FIG. 12 shows a fragment of an overlock sewing machine for manufacturing Magic Floss, according to an embodiment of the present invention.

FIG. 13 shows another fragment of an overlock sewing machine for manufacturing Magic Floss, according to an embodiment of the present invention.

FIG. 14 shows another fragment of an overlock sewing machine for manufacturing Magic Floss, according to an embodiment of the present invention.

FIG. 15 shows another fragment of an overlock sewing machine for manufacturing Magic Floss, according to an embodiment of the present invention.

Identical reference numerals or letters in the drawings generally refer to the same elements in different figures. A first-time introduced numeral or letter in the description is enclosed into parentheses.

### DETAIL DESCRIPTION OF PREFERRED EMBODIMENTS OF THE INVENTION

While the invention may be susceptible to embodiment in different forms, there will be described in detail herein, specific embodiments of the instant invention, with the understanding that the present disclosure is to be considered an exemplification of the principles of the invention, and is not intended to limit the invention to that as illustrated and described herein.

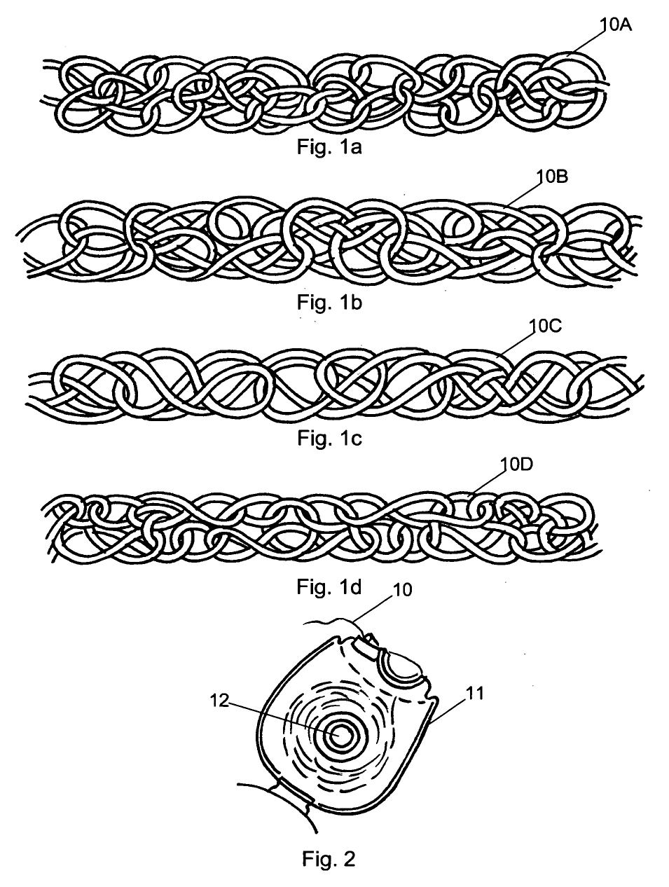

As mentioned hereinabove, the inventive knit structure of Magic Floss consists of a plurality of multi-stitch facets twisted in relation to each other along the longitudinal direction of the floss at predetermined angles. FIGS. 1a, 1b, 1c, and 1d illustrate a two-dimensional picture of the volumetric structure, showing a number of sample patterns of Magic Floss: (10)A, (10B), (10C), and (10D) in an enlarged scale.

Referring to FIG. 2, there is shown a preferred embodiment of packaging for Magic Floss, wherein an inventive floss (Magic Floss) (10) is wound up on a spool (12) placed in a casing (11), having an aperture for pulling the floss 10 out of the casing 11, wherein the aperture is preferably furnished with a means (not illustrated) for cutting the floss 10.

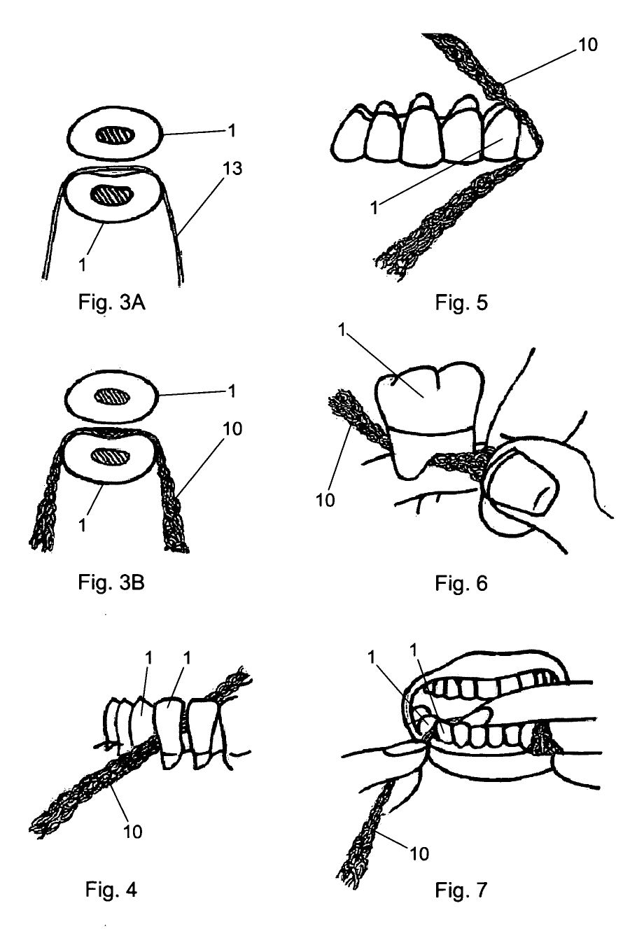

FIG. 3A depicts a conventional floss (13) positioned on the mesial surface of a maxillary first premolar (1). The picture shows the inability of the conventional floss 13 to remove bacterial plaque from a concave proximal tooth surface.

FIG. 3B illustrates the cleaning of the maxillary first premolar (i.e. tooth) 1 with the Magic Floss 10. It has a greater contact surface with the concave proximal tooth surface than the conventional floss 13.

FIG. 4 shows an effective cleaning and stimulation of the gingiva of embrasures with missing inter-dental papilla between the teeth 1 and 1 by the Magic Floss 10. The floss 10 is efficient due to its unique geometry. A looped plastic structure called a ‘floss threader’ (not shown) can be deployed as a leader to let the floss get between the teeth or under bridges.

The cleaning of the tooth 1 adjacent to the edentulous area is depicted on FIG. 5. A ‘shoe-shine stroke’ can be used to remove the bacterial plaque from the surface with the floss 10.

The cleaning of an exposed furcation area of the tooth 1 by inserting the Magic Floss 10 and moving it back and forth is shown on FIG. 6.

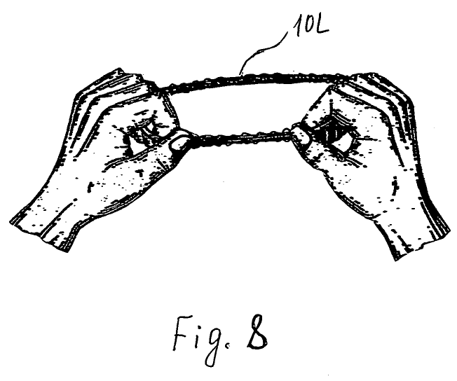

FIG. 7 illustrates the knit floss 10, which had reached the inter-dental space between two teeth 1. The floss 1 can be moved all the way down to the gum line to the triangular socket. The non-smooth surface of the Magic Floss area acts like tiny scoops with a brushing ability that helps in loosening and scooping away the debris of plaque retained in the interstices of the floss threads. Colored floss provides the visual contrast with plaque and debris.

FIG. 8 illustrates the endless loop embodiment of Magic Floss (10L) with the knit structure without a knot. During the flossing procedure, as one section of the floss 10L has done its cleaning, a fresh section of the loop can be easily rotated into the use without the rewinding and unwinding the floss from one hand into the other.

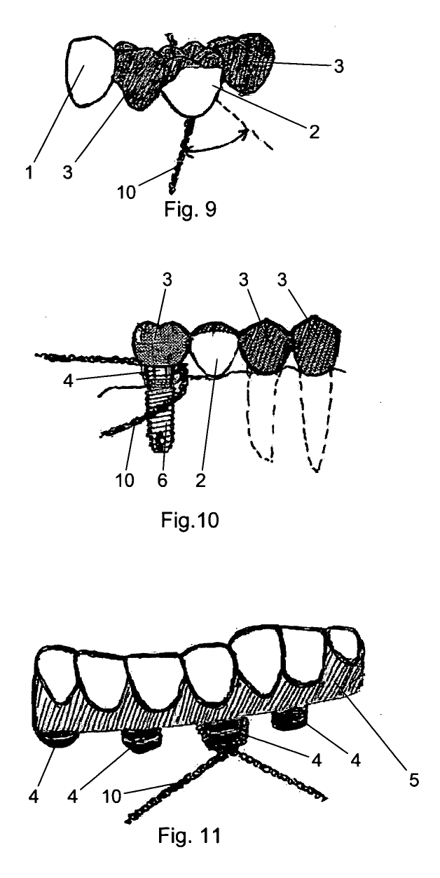

FIG. 9 is an illustration of the sliding of the floss 1 under a pontic (2). The floss 10 is moved back and forth several times as shown by the arrows to remove bacterial plaque from the gingival surface of the pontic 2, disposed between two crowns (3) next to a tooth 1.

FIG. 10 illustrates the cleaning around an abutment (4) located under a crown 3 disposed next to a pontic 2. The abutment 4 is coupled with an implant (6).

FIG. 11 illustrates the cleaning with Magic Floss 10 around an abutment 4, which supports a full denture (5) with other three abutments 4.

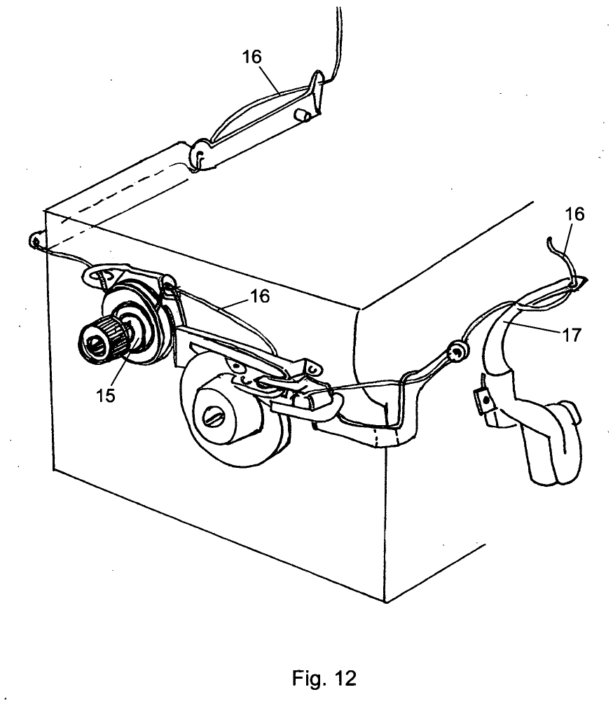

FIG. 12 shows detail parts of a common overlock sewing machine: a thread tension nut (15) used for adjustment of the tension of a side thread (16). The machine should be adapted for manufacturing the Magic Floss, particularly: only one double-chain looper (17) is to be used.

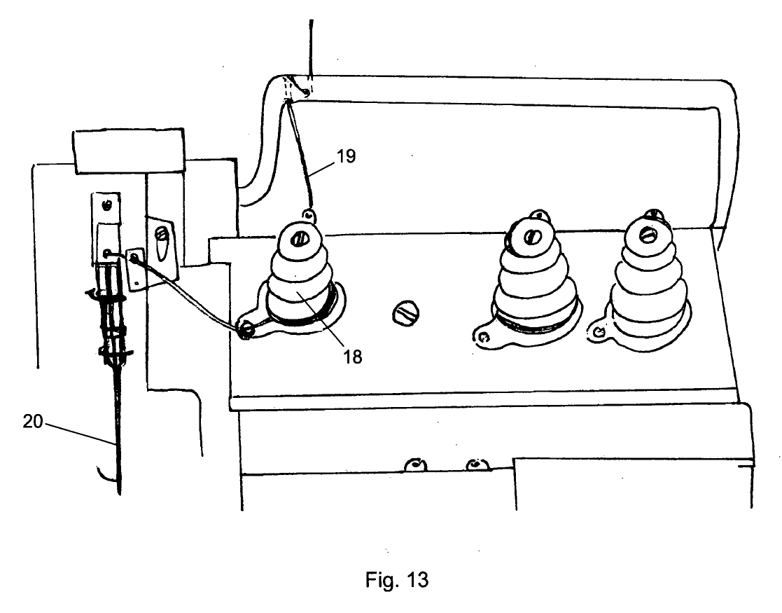

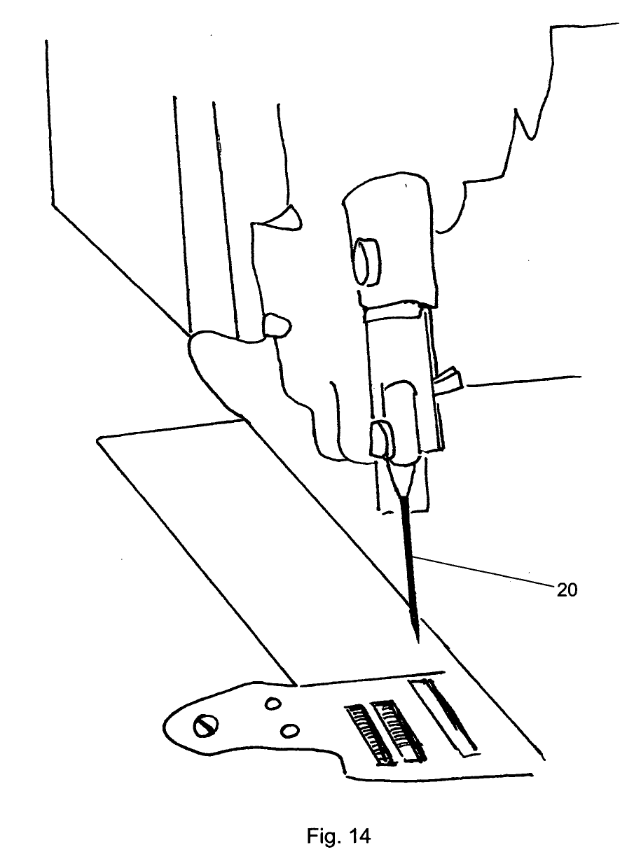

FIG. 13 depicts detail parts of a common overlock sewing machine: a thread tension nut (18) used for adjustment of the tension of a thread (19) in a needle (20). The machine should be adapted, particularly: tension nuts (21) and (22) are not used, i.e. threads are removed therefrom.

FIG. 14 illustrates a needle (20) without a presser foot that takes place when the Willcox and Gibbs overlock machines are deployed for manufacturing the Magic Floss.

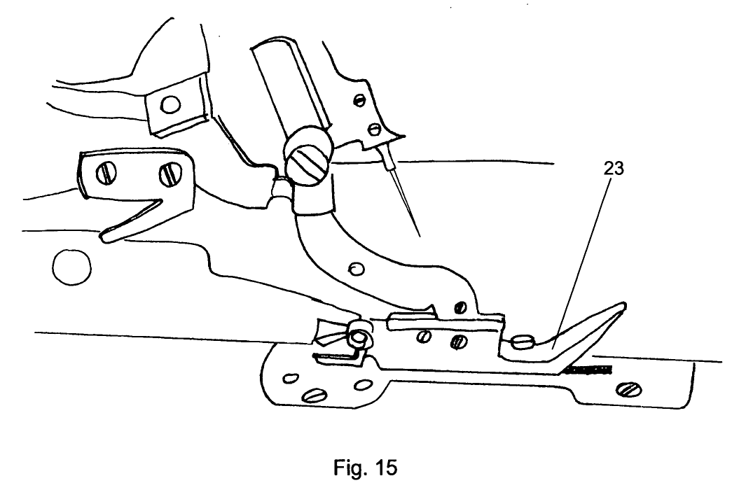

FIG. 15 is an illustration of adaptation of the Juki and Merrow overlock machines are deployed, in which case a presser foot (23) is used.

I claim:

1. A dental floss consisting of
a plurality of multi-stitch sections twisted in relation to each other along a longitudinal direction at predetermined angles providing a permanently changeable spatial orientation of the sections; said sections each consisting of
a plurality of strands braided with each other in a multi-stitch manner so that said sections collectively form a volumetric knit structure having a longitudinal axis;
said structure, being horizontally disposed, forms a projection on any axial plane, extended through the longitudinal axis, wherein said projection represents a planar pattern having an upper contour and a lower contour with a periodically changing width therebetween, thereby forming concave and convex portions.

2. The dental floss according to claim 1, wherein said strands are made of one of the following: silk, polyester, or of a combination of polyester and cotton threads.

3. The dental floss according to claim 1, wherein said floss is made in any of the following forms: un-waxed, waxed, or impregnated with predetermined therapeutic agents.

4. The dental floss according to claim 3, wherein said predetermined therapeutic agents include components selected from the group consisting of: ions of fluorine, sodium laurite, sodium perborate, alantoin, myrrh extract, charcoal, and xylitol.

5. The dental floss according to claim 1, wherein said floss is flavored with any of the following: mint, orange, lemon, cherry, strawberry, or vanilla.

6. The dental floss according to claim 1, wherein said floss is produced in a variety of predetermined colors.

7. The dental floss according to claim 1, wherein said floss is made as an endless loop.

8. The dental floss according to claim 1, wherein said floss is manufactured by means of a predeterminedly adapted conventional overlock machine.

9. The dental floss according to claim 1, wherein said floss is wound up on a spool, said spool is placed in a casing that has an aperture for pulling said floss out of said casing.
